(19) United States
(12) Patent Application Publication
(10) Pub. No.: US 2025/0383141 A1
(43) Pub. Date: Dec. 18, 2025

(54) A DOMESTIC APPLIANCE AND A METHOD FOR PROCESSING IMAGES IN A DOMESTIC APPLIANCE

(71) Applicant: BSH Hausgeräte GmbH, München (DE)

(72) Inventors: Christopher RODNEY, Villenbach (DE); Stephan KEMPFLE, Ellzee (DE); Daniel BIHR, Kirchheim am Ries (DE); Joachim SCHÄFERLING, Bissingen (DE)

(21) Appl. No.: 18/878,239

(22) PCT Filed: Jul. 6, 2023
(86) PCT No.: PCT/EP2023/068656

§ 371 Date: Dec. 23, 2024

(30) Foreign Application Priority Data
Aug. 22, 2022 (DE) 10 2022 208 678.3

(51) Int. Cl. F25D 29/00; G06V 20/52

(52) U.S. Cl. CPC F25D 29/005; G06V 20/52; F25D 2700/02

(57) ABSTRACT

A domestic appliance contains: a storage compartment delimited by a wall having a loading opening; a double-door assembly having two doors, wherein a trigger signal is output to a data-processing device when a door is closed; and a camera which is arranged on the wall and is configured to, upon receipt of a trigger signal, capture an image of the loading opening and transmit the image to a data-processing device. The camera has a dead time within which the camera cannot capture an additional image upon receipt of an additional trigger signal, and the data-processing device then generates, upon receipt of a trigger signal and an image captured as a result, an image section from the captured image if no additional trigger signal is received within the dead time. The image section shows the door which initiated the trigger signal, and, if an additional trigger signal is received within the dead time, the data-processing device additionally generates an additional image section from the captured image, which additional image section shows the other door.

The invention relates to a household appliance having a storage space delimited by a wall with a loading opening, a double-door arrangement with a first door and a second door for closing the loading opening, wherein the household appliance is configured to output a first trigger signal to a data processing facility when the first door is closed and to output a second trigger signal to the data processing facility when the second door is closed, a camera facility which is arranged on the wall of the storage space and is provided so as upon receipt of a trigger signal to capture an image of the loading opening and to transmit it to a data processing facility, wherein after receipt of a trigger signal the camera facility has a dead time within which it cannot capture a further image upon receipt of at least one further trigger signal, and the data processing facility is configured to generate an image section from the captured image upon receipt of a trigger signal and an image generated in response to the triggering of this trigger signal, said image section showing only that region of the loading opening which can be covered by the door which is triggering the trigger signal. The invention also relates to a method for processing images of a loading opening of a storage space captured by a camera facility of a household appliance with a double-door arrangement, wherein after receipt of a trigger signal the camera facility has a dead time within which it cannot capture a further image upon receipt of at least one further trigger signal, wherein in the context of the method, after a trigger signal is triggered, an image section is generated from the captured image, said image section showing only that region of the loading opening which can be covered by the particular door whose movement triggered the trigger signal. The invention can be used in a particularly advantageous manner on household appliances, in particular refrigerators with a “French-Door” double-door arrangement.

A household appliance of the type in question has the disadvantage that, if a further trigger signal is generated within the dead time, this trigger signal does not trigger a capturing of a further image and thus also an associated image section is not generated. If, for example,—even though seldom—the case occurs that the two doors of the double-door arrangement are closed almost simultaneously and in so doing trigger signals are triggered which follow each other within the dead time, an image section is generated solely for the particular door which triggered the trigger signal first.

It is the object of the present invention to overcome the disadvantages of the prior art at least in part.

This object is achieved in accordance with the features of the independent claims. Preferred embodiments can be seen in particular in the dependent claims.

The object is achieved by a household appliance apparatus, having
a storage space that is delimited by a wall with a loading opening,
a double-door arrangement with a first door and a second door for closing the loading opening, wherein the household appliance is configured so as upon the door being closed to output a respective trigger signal to a data processing facility,
a camera facility which is arranged on the wall of the storage space and is provided so as upon receipt of a trigger signal to capture an image of the loading opening and to transmit it to a data processing facility, wherein
after receipt of a trigger signal the camera facility has a dead time within which it cannot capture a further image upon receipt of at least one further trigger signal,
the data processing facility is configured so as upon receipt of a trigger signal and an image generated in response to the triggering of this trigger signal:
if a further trigger signal is not received within the dead time, to generate an image section from the captured image, said image section showing only that region of the loading opening which can be covered by the door which is triggering the trigger signal, and
if a further trigger signal is received within the dead time, to generate a further image section from the captured image, said further image section showing only that region of the loading opening which can be covered or closed by the other door.

This household appliance has the advantage that, upon a further trigger signal being triggered within the dead time, image sections can be generated for regions of the loading opening associated with both doors, although only one image has been captured and that was when the first trigger signal was triggered.

This is particularly advantageous if the data processing facility is configured, for example is programmed, to generate an image section for each image that has been generated in response to a trigger signal trigged by a movement of one of the doors. This development can be advantageous, for example, in order to be able to represent an inner face of the respective door in a particularly large view on a display facility with a limited display area. It is also achieved that in this case the same image format is always used.

The data processing facility can be a control facility of the household appliance and can be used in one development to activate the camera facility. In one development, the data processing facility is designed especially as a camera controller.

The household appliance can be a refrigerator, a freezer or a combination. The storage space is used to store food, in particular food to be cooled. Moreover, the household appliance can be an oven, a cooker or a dishwasher. The storage space of an oven is used to warm food, the storage space of a cooker is used to cook food and the storage space of the dishwasher is used to wash or clean crockery.

The wall of the storage space can also be referred to as an “inner liner”. The storage space can have one or more storage compartments and where appropriate also one or more drawer compartments, for example, for receiving drawers, for example for special climatic zones. The loading opening is in particular a front-side loading opening.

In one development, the double-door arrangement is a so-called “French Door” arrangement, in which both doors can pivot about a vertical axis and, viewing the household appliance from the front, a left-hand door is attached with its left side to a body of the household appliance, whereas a right-hand door is attached with its right side to the body. In one development, the two doors have the same width so that in the closed state they meet in the center of the storage space.

As is usual in the case of many refrigeration appliances, in particular refrigerators, the inner faces of the doors facing the storage space when the doors are closed are configured to store food to be stored, for example storage racks for bottles, butter, eggs etc.

That a respective trigger signal is output to a data processing facility when the door is closed includes in particular that the trigger signal is triggered during a process of closing the door, in particular upon achieving or not achieving a predetermined opening angle. An opening angle of zero can be equated to a closed door.

The camera facility comprises at least one image capturing sensor, in particular digital image capturing sensor, where appropriate also an evaluating and/or image processing electronic system. The camera facility can be part of a camera module. In one development, the camera module has additional functional units, for example an optical flash.

That the camera facility is arranged on the wall of the storage space can include that the camera facility is arranged on a ceiling, side wall or a base of the storage space. This arrangement results in a field of vision for the camera facility that is directed outward through the loading opening. In other words, the camera facility captures images through the loading opening in the outward direction. As a result, the camera facility can capture images of the inner faces of the door(s), and is also especially provided for this purpose. The camera facility is therefore located in particular in a region within the storage space and faces outward from the storage space.

That the camera facility is provided (i.e. configured and arranged) to capture an image of the loading opening includes in particular that the field of vision of the camera facility is so large that the loading opening lies at least in the most part, in particular completely, within the field of vision and thus an image of the loading opening is in the most part, in particular completely, displayed or shown. That the loading opening lies at least in the most part within the field of vision includes in particular that an image captured by the camera facility shows a region of the loading opening that leaves an upper and/or lower edge of no more than 5% of the height of the loading opening and/or a left and/or right edge of no more than 5% of the width of the loading opening free. In one development, the camera facility has a wide-angle or fish-eye lens upstream of an image sensor.

That after receipt of a trigger signal the camera facility has a dead time within which it cannot capture a further image upon receipt of at least one further trigger signal includes that, if the camera facility does capture an image upon receipt of a first trigger signal, a dead time (duration) exists within which the camera facility does not capture a further image upon receipt of a further trigger signal. The reason for this can be, for example that the camera facility requires a specific time period for capturing images and where appropriate storing images, processing images and/or transmitting images and this time period must have expired before the camera facility is ready to capture a further image.

In one development, the trigger signal is transmitted simultaneously to the camera facility and the data processing facility simultaneously. In this case, the trigger signal and shortly afterward the image that is generated in response to this trigger signal being triggered is typically received by the data processing facility.

In one development, the data processing facility can discriminate a received trigger signal, i.e. can recognize which door has been closed to result in the trigger signal being triggered. This can be implemented, for example, by the trigger signals for the two doors being received at different ports or connections on the data processing facility.

In one development, the data processing facility can assign a received image to a specific trigger signal. This can be implemented, for example, in such a way that, if the image is received within a specific delay period with regard to a trigger signal, it is assumed that the image has been captured in response to this trigger signal. It is thus also known which door has been moved to result in the image being captured. A further possibility resides in the fact that the transmitted image includes the information regarding in response to which trigger signal (i.e. a trigger signal triggered by which door) the image has been captured.

If a further trigger signal is not received within the dead time, only an image section which shows only the particular region of the loading opening that can be covered by the door which is triggering the trigger signal is generated from the received image.

The captured image shows both doors. The inner face of the (mainly still slightly at an angle but not closed) door, which has triggered the trigger signal, and the food that is to be stored and has been placed in said door is practically completely visible. The other door which has not triggered a trigger signal within the dead time, can be, for example, closed (in which case an image of the food to be cooked that is stored in this door is not relevant), still open, or rather also closed, but still noticeably further open than the door that triggered the trigger signal (in which case the food to be stored may be difficult or impossible to see in the image captured). As a rule, only the image of the inner face of this door is of interest to the user, which is why an image section is generated that shows only the inner face of this door, not the other door as well.

If, on the other hand, a further trigger signal is received within the dead time, this can represent the case where both doors or door leaves are closed practically at the same time. In this case, it is advantageous to have the image sections of both doors available, for example, for automatic object evaluation and, if necessary, subsequent storage and/or for viewing by a user.

In this case, a further image section is generated from the captured image generated only by the temporally first trigger signal, said further image section showing only that region of the loading opening that can be covered by the other door that generated the temporally following trigger signal and thus shows the inner face of that door. This makes use of the fact that although only the inner face of the door that generated the first trigger signal is shown in the best or “ideal” position in the image, the generally short time lag between the two trigger signals means that the inner face of the door that generated the following, second trigger signal is also shown in a sufficiently suitable position in the image, for example, for evaluation and viewing purposes.

In one embodiment, the data processing facility is designed in such a way that, if the further trigger signal is received during the dead time, the captured image is copied and the image section is generated from the copied image, said image section showing only that region of the loading opening that can be covered by the other door. This has the advantage that the data processing facility is particularly easy to program, since practically the same sequence routine can be used, for example to generate the first image section identically to the case without a further trigger signal during the dead time and to generate the second image section, which is only distinguished by a preceding simple copying process and the information that a trigger signal generated by the other door is assigned to the copied image.

In one embodiment, the data processing facility is configured to store the captured image temporarily, until the dead time has expired, and only then to generate the at least one image section. Thus, the advantage of a particularly simple implementation is achieved. This utilizes the fact that for the purposes of image evaluation and image viewing, the delay is practically insignificant in the context of the magnitude of the dead time when creating at least one image.

In one embodiment, the data processing facility is configured so as, when it receives a trigger signal triggered by one of the doors and within the dead time receives a trigger signal triggered by the other one of the doors, to generate a further image section from the captured image, said further image section showing only that region of the loading opening that can be covered by the other door. In this embodiment, the further image section is therefore only generated if the other (second) trigger signal received within the dead time has been triggered by the movement of a different door than the previous (first) trigger signal. This advantageously avoids an image section being generated as a result of both trigger signals being triggered by the same door (movement).

In one embodiment, the further trigger signal is a trigger signal generated by the first door or the second door. This is advantageously particularly easy to implement. In this case, the further trigger signal does not discriminate which door triggered it. It is assumed that it is highly unlikely that trigger signals will be trigged in succession by the same door (movement) within the dead time.

In one embodiment, the data processing facility is designed to transmit the at least one image section to at least one display facility. This has the advantage that a user can view the food to be stored that is placed in the inner face of the door. In particular, the image section can also be stored, in particular at least until a new image section belonging to this door has been generated. In one development, the at least one display facility comprises a display facility integrated into the household appliance, for example, a screen, in particular a touch-sensitive screen (“touch screen”). In one development, the at least one display facility is a display facility of an instance external to the household appliance. This advantageously enables a user to view the food to be stored depicted in the image section even when away from the household appliance, for example. when shopping. In this case, the household appliance can be equipped with a communication facility (for example a Bluetooth module, a WLAN module and/or an Ethernet module, etc.) that can be used to exchange data with the external instance. The instance that is external to the household appliance is, for example, a user terminal, in particular a mobile user terminal such as a smartphone or tablet PC.

In one development, the at least one image section is stored, for example for retrieval by a user when needed. In one development, the at least one image section is stored until it is replaced by a more up-to-date image section for the same door.

In one embodiment, the camera facility is arranged on a ceiling of the storage space wall. This advantageously allows an especially good view of the loading opening and thus of the inner faces of the doors.

In one embodiment, the doors have the same width (when closed and viewed from the front) and the camera facility is arranged in front view in the center of the ceiling of the storage space wall. This allows the camera facility to have an equally good view of both doors or halves of the loading opening. In particular, for doors of the same width, an image section can correspond to one of the halves of the loading opening, and for doors of different widths, it can correspond to side sections of the loading opening that have different widths.

In one embodiment, the dead time is no longer than 40 ms, and in particular no longer than 20 ms. This has the advantage that the inner face of the door whose movement triggered the trigger signal which was received during the dead time is always shown in a very suitable position in the image for evaluation and/or viewing purposes.

In one embodiment, the trigger signal is triggered, if, during a process of closing the door, a predetermined opening angle of this door is achieved or not achieved. This achieves the advantage that the inner face of the door can be captured in a defined, particularly suitable position and in fact in the relevant case that the door has been opened beforehand and food to be stored that is stored in the inner face of the door has been potentially removed and/or added.

In one development, the predetermined opening angle is in the range between 3° and 10°. This provides a good compromise between an image being advantageously captured to a large extent from the front and adequate illumination.

In one development, the trigger signal is generated by means of a trigger facility that is configured to trigger the trigger signal if during a process of closing the door a predetermined opening angle of the door is achieved or not achieved. In one development, the trigger facility generates a trigger signal if, in addition, at least one condition is met, for example in addition to achieving or not achieving the specified opening angle, a closing speed of the door is above a specified threshold value.

In one development, a trigger facility monitors the movement of both doors. This can be advantageous in order to keep the number of trigger facilities small, such a trigger facility can be, for example, a camera-supported monitoring facility, an ultrasound, radar, or LiDAR monitoring facility etc.

In one development, each of the two doors is assigned a respective trigger facility. This achieves the advantage that the occurrence of the condition at which the trigger signal is triggered can be determined particularly accurately and with little evaluation effort. In one development, the trigger facility is installed in the respective door.

In one embodiment, the trigger facility is a gyro sensor, in particular the trigger signal can be triggered by means of a gyro sensor arranged on the relevant door. The gyro sensor has the advantage of being compact, particularly easy to mount and calibrate, and it can also detect angle changes and angular velocities of the door with a high degree of accuracy.

In one embodiment, the household appliance has at least one further camera facility which is provided to capture images of the storage space and/or of the open storage space drawers and to transmit them to the data processing facility. This at least one further camera facility can be, for example, a camera facility which is arranged in at least one door and which is provided to capture at least one image of the storage space. This at least one further camera facility can additionally or alternatively comprise a camera facility which is provided to capture at least one image of an open storage space drawer. This camera facility can be arranged for example on a ceiling of the storage space wall, in particular in a common module with the camera facility provided for carrying out the method described above.

The object is also achieved by a method for processing images of a loading opening of a storage space captured by a camera facility of a household appliance with a double-door arrangement, wherein after receipt of a trigger signal, the camera facility has a dead time within which it cannot capture a further image upon receipt of at least one further trigger signal, wherein in the context of the method:
if a further trigger signal is not triggered within the associated dead time after a trigger signal is triggered by one of the doors of the double-door arrangement, an image section is generated from the captured image, said image section showing only that region of the loading opening which can be covered by the particular door whose movement triggered the trigger signal, and
if a further trigger signal is triggered within the dead time, a further image section is generated from the captured image, said further image section showing only that region of the loading opening which can be covered by the other door.

The method can be designed analogously to the household appliance, and vice versa, and has the same advantages.

The above described characteristics, features and advantages of this invention and the manner in which these are achieved are more clearly and more precisely understandable in conjunction with the following schematic description of an exemplary embodiment that is explained in detail in connection with the figures.

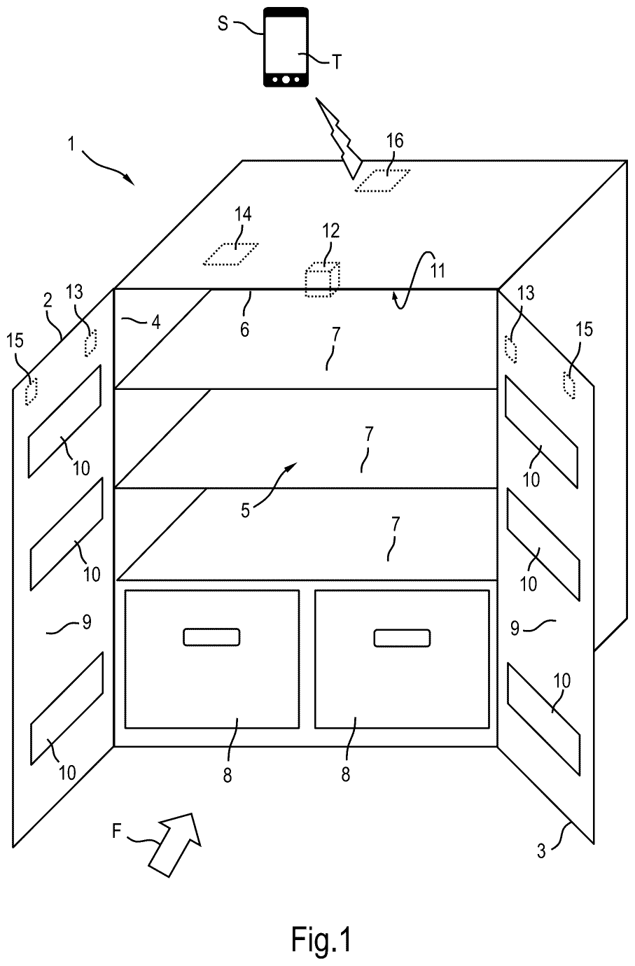

FIG. 1 shows a sketch of a household appliance with a double-door arrangement, viewed obliquely from the front;

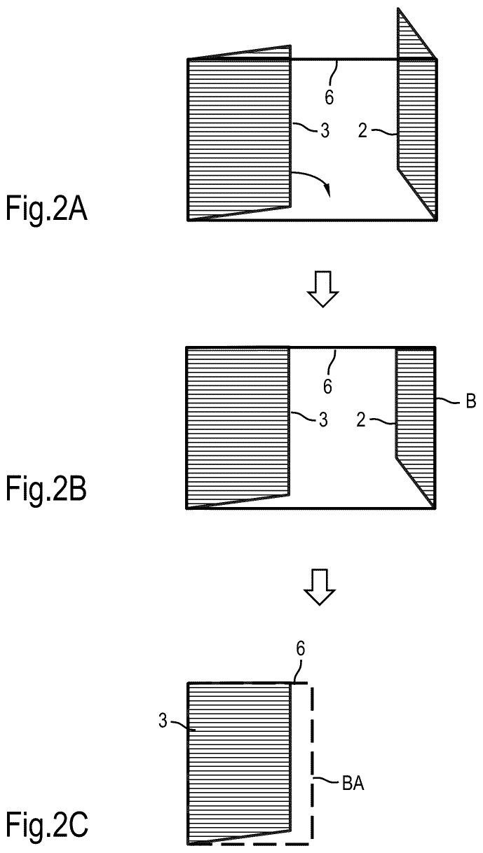

FIGS. 2A to 2C schematically show a possible sequence of a method for processing images captured by a camera facility of the household appliance shown in FIG. 1; and

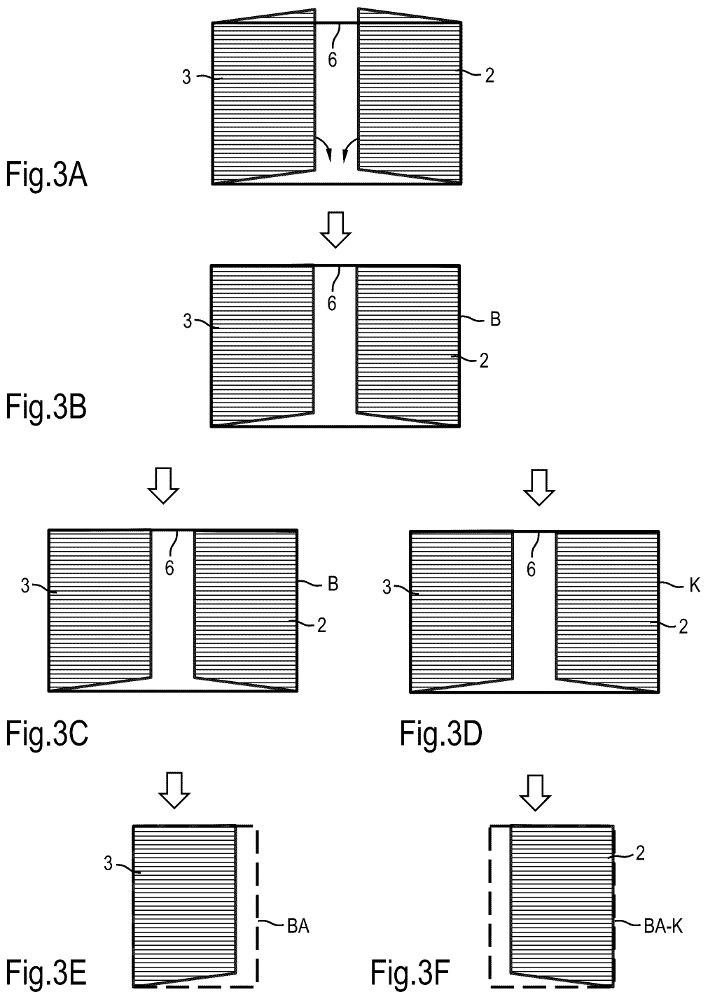

FIGS. 3A to 3F schematically show another possible sequence of a method for processing images captured by a camera facility of the household appliance shown in FIG. 1.

FIG. 1 shows, viewed obliquely from the front, a sketch of a household appliance in the form of a refrigerator 1 with a French-door double-door arrangement 2, 3, which has a first, here: left-hand door 2 in a front view F and a second, here: right-hand door 3, both of which are drawn in an open position. The refrigerator 1 also has a storage space 5 or refrigeration compartment which is delimited by a wall 4 and has a front-side loading opening 6. Storage compartments 7 and drawers 8 for storing food are provided in the refrigeration compartment 5. Food storage shelves 10 are also provided on the inner faces 9 of the doors 2, 3. A camera facility 12 is arranged in front view F in the center of a ceiling 11 of the storage space wall 4, the camera facility being configured to capture an image of the loading opening 6.

A trigger facility in the form of a gyro sensor 13 is arranged in the doors 2, 3. The gyro sensor 13 can detect at least one angle change of the associated door 2, 3, a direction of rotation and where appropriate an angular velocity, from which it is possible to determine an opening angle of the door 2, 3. In the present case, a trigger signal is triggered by the gyro sensor 13, if the door 2, 3 is closed and a specific opening angle is achieved or not achieved, for example of 3°. The trigger signal is transmitted to the camera facility 12 and a data processing facility 14. Upon receipt of the trigger signal, the camera facility 12 is triggered so as to capture an image of the loading opening 6 and to transmit it to the data processing facility 14.

The refrigerator 1 can also have further camera facilities, for example camera facilities 15 which are provided in the doors 2, 3 and are provided to capture images of the refrigeration compartment 5 and to transmit them to the data processing facility 14.

The data processing facility 14 is configured so as, upon receipt of the trigger signal and an image B (see FIG. 2B) generated in response to this trigger signal being triggered, to generate an image section BA (see FIG. 2C) from the captured image B, said image section showing that region of the loading opening which can be covered by the door 2, 3 which is triggering the trigger signal. If the trigger signal is generated by the left-hand door 2, the image section BA shows the left half of the loading opening in the front view F or, from the point of view of the camera facility 12, the right half of the loading opening 6 and thus also the inner face 9 of the door 2. This applies analogously to the right-hand door 3.

The data processing facility 14 is also configured to transmit the image section BA to at least one display facility, for example, to a screen on the refrigerator (not shown) or to a mobile user terminal such as a smartphone S, wherein the image section can be displayed on the screen T of said display facility, for example by means of an appropriate application program (“app”). For this purpose, the refrigerator 1 can be equipped with a communication module 16 such as a WLAN module, Bluetooth module or Ethernet module.

FIG. 2A to FIG. 2C show a possible sequence of a method for processing images captured by the camera facility 12 in the event that the data processing facility 14 receives a trigger signal from the gyro sensor 13 of one of the doors 2, 3 (here, for example, door 3) and a further trigger signal is not received within a dead time of the camera facility 12 of, for example, 20 ms, in particular is not received from the gyro sensor 13 of the other door 3, 2 (here, for example, door 2). The dead time corresponds to a period of time within which the camera facility 12 cannot capture a further image upon receipt of at least one further trigger signal.

FIG. 2A shows the loading opening 6 and doors 2, 3 from the direction of the camera facility 12, wherein the left-hand door 2 is wide open and the right-hand door 3 has achieved the opening angle to trigger the trigger signal (“trigger angle”) during a closing movement indicated by the arrow.

Thereupon, the camera facility 12 captures an image B of the loading opening 6 as shown in FIG. 2B and transmits it to the data processing facility 14.

The data processing facility temporarily stores the image B for at least the duration of the dead time (“delay time”). If the delay time has expired and a further trigger signal has not been received from one of the doors 2, 3, in particular door 2, within the delay time, the captured image B is cropped in a following step to form an image section BA that shows only the (in front view) right half of the loading opening 6, which can be covered by the door 3, as shown in FIG. 2C. This is done on the basis of the knowledge that the trigger signal has been triggered by the gyro sensor 13 of the right-hand door 3, for example, because the image B has been received within a specific period of time after receipt of the trigger signal of the right-hand door 3.

FIG. 3A to FIG. 3F show a possible sequence of a method for processing images captured by the camera facility 12 in the event that both doors 2, 3 are closed and thereby achieve their respective trigger angle within the dead time, as indicated in FIG. 3A. For example, it is assumed that the right-hand door 3 achieves the trigger angle first and then the left-hand door 2 achieves the trigger angle within the dead time of, for example, 20 ms.

When the right-hand door 3 achieves the trigger angle, an image B of the loading opening 6 is captured (FIG. 3B) and transmitted to the data processing facility 14, analogous to FIG. 2B. Since the trigger signal generated by the closing movement of the left-hand door 2 is received by the camera facility 12 within the dead time, an image is not generated by this second trigger signal.

The data processing facility also temporarily stores this image B for the duration of the delay time and monitors whether a second trigger signal is received within the dead time, which is the case here. Thereupon, a copied image K which is displayed in FIG. 3D is copied from the captured image B shown in FIG. 3C and stored temporarily.

The data processing facility 14 now generates, in a manner analogous to FIG. 2C, from the image B the image section BA shown in FIG. 3E which shows the (in front view) right half of the loading opening 6, and from the copied image K the image section BA-K shown in FIG. 3F which shows the (in front view) left half of the loading opening 6 which can be covered or closed by the right-hand door 2. The two image sections BA and BA-K can be transmitted to the at least one display facility T and/or stored for retrieval, for example, by a user.

Of course, the present invention is not limited to the exemplary embodiment shown.

Generally, “a”, “an” etc. can be understood as a singular or a plural, in particular in the sense of “at least one” or “one or more” etc., as long as this is not explicitly excluded, for example, by the expression “exactly one” etc.

A numerical value can also include exactly the specified number as well as a usual tolerance range, as long as this is not explicitly excluded.

### LIST OF REFERENCE CHARACTERS

1 Refrigerator
2 Left-hand door
3 Right-hand door
4 Wall
5 Storage space
6 Loading opening
7 Storage shelf
8 Drawer
9 Inner face of a door
10 Food storage compartment
11 Ceiling of the wall
12 Camera facility
13 Gyro sensor
14 Data processing facility
15 Camera facility
16 Communication module
B Image
BA Image section
BA-K Image section
F Front view
K Copied image
S Smartphone
T Screen

1-12. (canceled)

13 A household appliance, comprising:
walls delimiting a storage space with a loading opening;
a double-door configuration including a first door and a second door for closing said loading opening;
a data processor receiving a respective trigger signal from the household appliance when a door of said double-door configuration is closed;
a camera disposed on said wall of said storage space and being provided so as upon receipt of the respective trigger signal to capture an image of said loading opening and to transmit the image to said data processor;
wherein:
after receipt of the respective trigger signal, said camera has a dead time within which said camera cannot capture a further image upon receipt of at least one further trigger signal;
said data processor is configured so as upon receipt of the respective trigger signal and the image generated in response to a triggering of the respective trigger signal:
to generate an image section from the image captured if the at least one further trigger signal is not received within the dead time, said image section showing only that region of the loading opening which is covered by the door which is triggering the respective trigger signal; and
to generate in addition a further image section from the image captured if the at least one further trigger signal is received within the dead time, the further image section showing only that region of the loading opening which is covered by an other door.

14. The household appliance according to claim 13, wherein said data processor is configured so as, if the at least one further trigger signal is received within the dead time, to copy the image captured and to generate the image section from a copied image, the image section showing only that region of the loading opening that is covered by the other door.

15. The household appliance according to claim 14, wherein said data processor is configured to temporarily store the image captured until the dead time has expired, and only then to generate the image section and/or the further image section.

16. The household appliance according to claim 13, wherein said data processor is configured so as, when it receives the respective trigger signal triggered by one of the doors and within the dead time receives the at least one further trigger signal triggered by the other one of the doors, to generate a further image section from the image captured, the further image section showing only that region of the loading opening that is covered by the other one of the doors.

17. The household appliance according to claim 13, wherein the at least one further trigger signal is a trigger signal generated by the first door or the second door.

18. The household appliance according to claim 13, further comprising at least one display facility, said data processor is configured to transmit the image section and the further image section to said at least one display facility.

19. The household appliance according to claim 13, wherein one of said walls is a ceiling delimiting a part of said storage space, said camera is disposed on said ceiling.

20. The household appliance according to claim 19, wherein said first and second doors have a same width, and said camera is disposed in front view in a center of said ceiling delimiting the storage space.

21. The household appliance according to claim 13, wherein the dead time is not longer than 40 ms.

22. The household appliance according to claim 13, further comprising a gyro sensor disposed on at least one of said first and second doors, wherein the respective trigger signal is triggered by means of said gyro sensor if a predetermined opening angle of said one door is achieved or not achieved during a process of closing said one door.

23. The household appliance according to claim 13, further comprising:
storage drawers; and
further cameras provided to capture images of said storage space and/or of open said storage drawers and to transmit captured images to said data processor.

24. The household appliance according to claim 13, wherein the dead time is not longer than 20 ms.

25. A method for processing images of a loading opening of a storage space captured by a camera of a household appliance with a double-door configuration, wherein after receipt of a trigger signal the camera has a dead time within which it cannot capture a further image upon receipt of at least one further trigger signal, which comprises the steps of:
generating an image section from a captured image if after the trigger signal is triggered by a door of the double-door arrangement a further trigger signal is not triggered within the dead time, the image section showing only that region of the loading opening which is covered by the door whose movement triggered the trigger signal; and
generating a further image section from the captured image if a further trigger signal is triggered within the dead time, the further image section showing only that region of the loading opening which is covered by an other door of the double-door arrangement.
